(19) United States
(12) Patent Application Publication
(10) Pub. No.: US 2007/0259324 A1
(43) Pub. Date: Nov. 8, 2007

(54) Computerized medium for exchanging contents of interest

(75) Inventor: Zvi Frank, Cambridge, MA (US)

Correspondence Address: GIBBONS P.C., ONE GATEWAY CENTER, NEWARK, NJ, 07102, US

(73) Assignee: Interwise Ltd.

(21) Appl. No.: 11/429,718

(22) Filed: May 8, 2006

(51) Int. Cl. G09B 3/00

(52) U.S. Cl. 434/322

(57) ABSTRACT

An interactive system for the exchange of knowledge over a network, including, a server that is accessible by user client stations via a communication network, an interactive knowledge exchange application for running on the server, wherein the application is adapted to enable a user to log on to use the application as an instructor or a student. Wherein a user logged on as an instructor can provide an online course for teaching students, and a user logged on as a student can select to participate online in courses offered by instructors.

### FIELD OF THE INVENTION

The present invention is generally in the field of information exchange over a computer network. More specifically, the invention relates to a computerized medium linked to a computer network, allowing clients to exchange information between them.

### BACKGROUND OF THE INVENTION

The rapid development of computerized networks including intranets and the Internet, has seen a parallel development of computerized media allowing network users to deliver and receive data to and from other users. The Internet saw the creation of many so-called “virtual open universities” which permit clients to log in and then participate, through the network, in one or more teaching sessions or course provided by the “virtual open university”.

The virtual open universities which may be accessed over the Internet today, provides a list of courses, and allows clients to log-in and participate in one of the teaching sessions or courses provided by the virtual open university, and delivered through the computer network by instructors designated by the virtual open university. The general architecture of such systems can be seen in FIG. 1. The virtual open university generally designated 20 consists of a server 22 with a student interface 24 and an instructor interface 26. A plurality of instructors I₁, I₂ . . . Iₙ, may link to the virtual university 20 through the instructor interface 26 and this permits them to initiate teaching sessions to a plurality of students S₁, S₂ . . . Sₙ. Students S₁, S₂ . . . Sₙ, may link to server 22 through the student interface 24, select teaching sessions or courses from a list provided by instructors I₁, I₂ . . . Iₙ. It is a common feature of all virtual open universities that the courses provided are pre-selected by the open university provider together with the instructors. Each user is originally defined either as an instructor or a student. A characteristic feature of the available virtual universities is that there is a very clear segregation between instructors and students.

Computer networks are to a large extent media allowing posting and retrieval of information. Many users of computer networks have knowledge which may be valuable to other users. The Internet provides a medium for free exchange of information between different users of the Internet, however mutual provision of information to users is achieved, in the Internet environment, either through posting of web pages or through chat media.

### SUMMARY OF THE INVENTION

In accordance with the present invention a novel computerized network-linked, consumer to consumer (C2C), content exchange medium is provided permitting each of the system's clients to be either a provider or a recipient of such content of interest. The virtual contents exchange medium (VCEM) allows trading contents of interests, within teaching sessions or courses, between the clients. In other words, rather than being a medium resembling today's academia, such as the virtual open universities available over the Internet where instructors are a defined, closed group of clients, in the VCEM of the invention, the role of the provider of commodity is open to and can be assumed by every client. Thus each client of the system can initiate and deliver one or more sessions or courses (each “course” being a succession of sessions which together cover a certain topic of interest) for teaching a certain content of interest to one or more other clients of the VCEM system.

The invention thus provides a system for exchanging contents of interest comprising information, data or knowledge between a plurality of clients communicating with a server through a computer network, the server connecting the clients to one another, characterized in that:

1. The content of interest is delivered by at least one client to one or more other clients, in a teaching session in which the clients participate by linking to one another through the server.

2. Each client of the system can select to be a provider or a recipient of the contents of interest.

In accordance with one preferred embodiment, the present invention provides a computerized system for communicating contents of interest between clients, including:

1. A server linked to a computer network, permitting a plurality of computerized clients to connect thereto.

2. A software loaded on the server and providing; a virtual environment permitting clients to select and participate in a teaching session in which at least one client, serving as a provider, delivers a content of interest to one or more other clients of the system. A virtual client interface permitting a client to define himself as either a provider or a recipient of a content of interest and selectively define or select the contents of interest; an account management software for maintaining and controlling accounts of clients and for retrieving payments from a client account who is a recipient of the contents of interest and inputting payment into an account of a client who is a provider of the contents of interest, based on a predetermined price of the exchanged contents of interest.

The system may also include providing technical support (back-office assistance) for the providers of the contents of interest and optionally also for the recipients of such contents, typically regarding the use of the software required for constructing a course or a session or during the course or sessions themselves.

The client interface typically comprises a provider interface to which the client is prompted after defining itself as a provider or a recipient interface to which the client is prompted after defining itself as a recipient. The recipient interface may consist of data pages providing information on topics for teaching sessions or courses which are available, listing the time-table of such courses, particulars of the instructors, etc. The different courses may be ordered and grouped by subject, by data presentation, by rank (for example a rank of quality based on student feedback), rank by popularity, etc. In addition, the recipient interface will also permit the recipient to review the costs for each teaching session or course. The provider interface may permit the provider to define and post a course of a certain topic he wishes to deliver, permit him to review course of similar topics, provided or being delivered, providing tools assisting him in the preparation of a teaching session, etc. Furthermore, the recipient interface and the provider interface may provide mutual links allowing a client to move from one to the other.

As can be appreciated from the above, and as will also be clarified by the description below, the system of the invention serves as a kind of exchange permitting the trading of commodities between clients (e.g. similar to Ebay (www.ebay.com), wherein the commodities being traded are teaching sessions or courses. In an exemplary embodiment of the invention, a client may offer to provide a course on specific dates, for a specific price or to a limited number of participants providing the highest price offer starting from a minimum value specified by the client. Optionally, the price of the course may be determined in each case between the client and the course provider, e.g. automatically by predefined parameters, or by a preset value set by the course provider or by interaction between clients. Regardless of the mechanism of setting the price of the teaching session or course, this value is monitored by the account management software to credit or debit a client's account, as the case may be, accordingly. Optionally, a percentage of the transferred funds are credited to the application for providing the matching service and providing tools for conducting the course.

The term “teaching session” or “course”, which are used interchangeably in the specification refer to an interaction between clients, over a continuous time sequence, in which at least one client, serving as a provider of the commodity, delivers through the computer network a topic of interest to one or more other clients, being recipients in such a teaching session. A teaching session, as will also be pointed out further below, the delivery of a teaching session may be live, wherein the providers and the recipients are linked to one another at the same time and the topic of interest is delivered from the providers to the recipients in real time. In some embodiments of the invention, a teaching session is an interactive session whereby a recipient can interact with the provider, recipients can interact with one another, etc. However, it should be noted that it is possible at times also to pre-record a teaching session, where circumstances do not allow a provider to be available at the time of the session, or when a recipient misses a session and wishes to receive the contents of interest at a later time.

The provider of the contents of interest is a client that is also referred to herein below as an “instructor”. Optionally, this term may be used interchangeably with the term “provider”. The recipient of said content of interest is a client also referred to herein below as a “student” and may be used interchangeably with the term “recipient”. The computerized medium of the invention operates as a virtual exchange medium in which a user, defined as an “instructor”, can initiate a “teaching session” to transmit a lesson or a course to other clients, defined as “students”.

As will be appreciated, the term “instructor” encompasses one or more clients involved in delivering a teaching session or a course to other clients. Typically, the instructor will be a single client although at times two or more clients may cooperate together in delivering a single teaching session or course. The term “instructor” encompasses also such a group of clients cooperating in delivering a teaching session or a course.

The system of the invention is actually a virtual contents exchange medium (VCEM) permitting any client to be both a student and an instructor, namely it is open for everybody to serve both functions. A client, when linked to the VCEM in the capacity of an instructor will be referred to herein as an “instructor”, while when linked to the VCEM in the capacity of a student, will be referred to herein as a “student”. It is however understood that the use of these terms is for convenience only and is clear that at other times the instructor may be a student and vice versa.

The present invention also provides a server linked to a computer network, allowing connection thereto of a plurality of clients, the server being loaded with a software permitting the server to serve as a virtual contents exchange medium in which one or more clients can participate in a teaching session or a course provided by at least one other client; the server being loaded with a software permitting each client to define himself as one or both of:

1. An instructor for delivering one or more teaching sessions or courses to one or more other clients;

2. A student for participating in one or more teaching sessions or courses provided by instructors;

In an exemplary embodiment of the invention, the server is loaded with a software for managing clients' accounts and crediting clients serving as instructors based on the level of participation of student clients in their delivered teaching sessions or debiting a client account based on the level of his participation as a student in a teaching session, provided by instructor clients.

The term “server” as used herein means to denote a computerized system, comprising one or more computers, serving as the contents exchange medium of the invention. The term “server” used above and further below should not be understood in the physical sense but rather in a functional way. Thus, the server may be a single computer acting as a server or may consist of a plurality of servers operating together.

The system of the invention may utilize also an agent software loadable on the client's computer, being either instructor software or a student software. This software may be downloadable to the client's computer through the network or may be provided on a computer readable medium such as a CD ROM, a magnetic disk, tape, memory chip, etc. Such a computer program product is also an aspect of the invention. The invention thus provides in accordance with this aspect a computer program product directly loadable on a computer, comprising computer program code which when loaded onto the computer, allows the computer to participate as a client in the above defined system or method.

As already pointed out above, the teaching sessions may be live or may be pre-recorded. In addition, a teaching session may involve a combination of live presentation and pre-recorded portions. In computer networks, the band-width for transmission of data is limited and band-widths problems may at times serve a bottle neck for the transmission of large files such as video clips, over the network in real time. Thus, large files such as video clips may be transferred to a student client from the server ahead of time so as to be available on his computer, for activating at the appropriate time during a teaching session. In order to permit on time opening or activation of such files, a synchronization software may be provided, loaded both on instructor and student computers, permitting the instructor remote activation of the provided content on the student stations.

A preferred computer network for the system is the Internet. In the following, the invention will be described with reference made to the Internet as the network over which the system operates, it being understood, however, that this is an example only and the system may similarly operate through other computer networks, for example through intranets.

In an exemplary embodiment of the invention, teaching sessions are made through the use of virtual classrooms. A virtual classroom may be a temporary site limited in access only to the instructor and to the students registered for the specific teaching session or course. Optionally, each of the students participating in a teaching session may typically have a display on their computer screen showing the virtual classroom which may include a virtual blackboard on which the instructor may draw sketches, write notes or provide any type of content which can be seen by the students, for example presenting slides, video clips, etc. In some embodiments of the invention, the instructor may have a graphical or pictorial representation of the students and/or the instructors participating in the teaching session. In some embodiments of the invention, the virtual classroom may provide live audio communication between the participants. In some embodiments of the invention, the virtual classroom environment may be designed to permit the instructor to receive files from a student, e.g. a paper which the student prepared, and/or to receive, questions from the student which may be in the form of voice or text; answer questions to a specific student or to the entire classroom; convey a message to one student; permit different students to communicate with or without the instructor's knowledge, such as to deliver messages between them, e.g. exchange E-mails, learning material, arrange time for meeting over the Internet to discuss the delivered content of interest; etc. As will be appreciated, the identity of the students may be made known to the instructor or the other students, or each student may conceal his true identity and be identified by a designation, which may be personally chosen or designated by the system.

The instructor interface, optionally in combination with an instructor software, may permit an instructor to prepare lessons and deliver a live and interactive teaching session for a virtual classroom of students. The system may permit the instructor to establish a voice connection with the students by employing appropriate protocols for transmission of audio through the network. The system may also provide a video communication means to transmit images, to transmit live or pre-recorded video clips relating to the delivered content, etc. Contingent with the communication channel band-width available to the instructor and the students, the voice or the teaching session may also involve at times live unidirectional or bi-directional video communication between the instructor and the students. In addition, the instructor interface may permit an instructor to prepare learning materials off-line, to send E-mail messages to students advising them of things they need to prepare for a lesson, as well as receive E-mail messages from students to answer questions, etc. The instructor interface may also allow the instructor to transmit a certain software application to a student which may be required for a specific session, e.g. a picture-processing software to allow a student to view pictures which form part of a lesson, etc.

The student interface permits the students to view lists of courses, the course schedules and allow them to select a session or course of interest. Optionally, when wishing to obtain information on a specific course, a student may typically press on the course's icon displayed on his screen and receive more detailed information on the topic of a specific course, session times, the course's length, teaching and hardware aid required for the course, price, as well as particulars of the instructor biography, credentials and evaluation.

The system may also provide a virtual clipboard allowing clients to place notes to be picked-up by other clients. For example, a client may place a note relating to a certain content of interest for which a course is not yet available and which they would desire. This would permit another client, who has the necessary knowledge, to view such a clipping and then prompt them to deliver the requested course.

The VCEM in accordance with the invention may provide also a virtual campus which permits a visiting client to navigate in the virtual university to obtain information on courses, chat with other students and obtain information on courses from them, and in general obtain any other information desired on the VCEM and its activities. The system of the invention may also have an administration interface permitting a user to enter and obtain information on his account, information about his grades, receive student evaluations of instructors, etc.

The system may also comprise a virtual library or bookstore permitting a student to review, download or purchase papers or books of interest particularly such which may be relevant to courses in which they participate.

In some embodiments of the invention, access to the library or bookstore may be permitted only to students enrolled in specific courses and otherwise limited to incidental ‘visitors’ to the VCEM.

There is thus provided according to an exemplary embodiment of the invention, an interactive system for the exchange of knowledge over a network, including, a server that is accessible by user client stations via a communication network, an interactive knowledge exchange application for running on said server, wherein the application is adapted to enable a user to log on to use said application as an instructor or a student, wherein a user logged on as an instructor can provide an online course for teaching students; and wherein a user logged on as a student can select to participate online in courses offered by instructors. Optionally, the application allows the instructor to specify a schedule for the provided course. In some embodiments of the invention, the application allows the instructor to specify a fee for the provided course. Optionally, the application allows the instructor to specify the subject of the provided course.

In some embodiments of the invention, the provided course is conducted with live participation of the instructor. Optionally, the application provides the instructor with a virtual blackboard, which displays for the students the content which is provided by the instructor. In some embodiments of the invention, the application provides the instructor with live voice communication to the participating students. Optionally, the application provides the students with live voice communication with the instructor. In some embodiments of the invention, the application provides the students with live voice communication among themselves. Optionally, the instructor controls communication between the participating students. In some embodiments of the invention, the application enables the delivery of course material to the participating students. Optionally, the application provides the instructor with the ability to selectively send messages to participating students.

In some embodiments of the invention, the application enrolls students wishing to participate in a course. Optionally, the application accepts payment from students to participate in a course. In some embodiments of the invention, the application conducts a list of available courses. Optionally, the list can be searched by the subject of the available courses, the popularity of the available courses, the quality of the available courses, the length of the available courses, or the price of the available courses. In some embodiments of the invention, the application provides payment to the instructors for providing a course based on the participation in the course. Optionally, the application enables participants of a course to contact each other. In some embodiments of the invention, the application provides a course instructor with a list of the participants. In some embodiments of the invention, the application provides a course participant with a list of the participants in the course. Optionally, the application accepts feedback from the course participants ranking the quality of the course. In some embodiments of the invention, the application accepts feedback from the course participants ranking the ability of the instructor. Optionally, the application enables multiple instructors to conduct a course together from different workstations.

In some embodiments of the invention, participation in a course requires installation of an agent application on the client station. Optionally, the agent application prevents copying content provided to the student. In some embodiments of the invention, the agent application assures payment for participation in a course. Optionally, the agent application tracks usage of course material by the student. In some embodiments of the invention, the agent application limits usage of course material to a specific time schedule. Optionally, the agent application allows access to the student workstation by the instructor.

In some embodiments of the invention, the application accepts requests and provides a list of subjects of interest for instructors to provide courses. Optionally, the application enables communication between clients of the system for the exchange of information. In some embodiments of the invention, the application provides instructors with feedback from the students regarding courses provided by the instructor. Optionally, the application prevents provision of courses on offensive subjects. In some embodiments of the invention, the application prevents provision of courses by undesirable instructors. Optionally, the application provides students the ability to view sample lessons. In some embodiments of the invention, the system takes a percentage of any payment collected from a student for participating in a course. Optionally, the application records live courses and offers them at a later time as not live courses. In some embodiments of the invention, a course may be provided on condition that a minimum number of students participate. Alternatively, a course may be limited to be provided to a single student. In some embodiments of the invention, a course may be provided to a limited number of participants providing the highest price bid.

### BRIEF DESCRIPTION OF THE DRAWINGS

The present invention will be understood and appreciated more fully from the following detailed description taken in conjunction with the drawings. Identical structures, elements or parts, which appear in more than one figure, are generally labeled with the same or similar number in all the figures in which they appear, wherein:

FIG. 1 is a schematic block diagram of a prior art virtual university, as described above;

FIG. 2 is a schematic block diagram of a virtual contents exchange medium, according to an exemplary embodiment of the invention;

FIG. 3 is a schematic flow chart of the connection sequence of the client connecting to the system, according to an exemplary embodiment of the invention;

FIG. 4 is a schematic flow chart of the sequences involved in selection and participation of clients in a teaching session, according to an exemplary embodiment of the invention.

### DETAILED DESCRIPTION

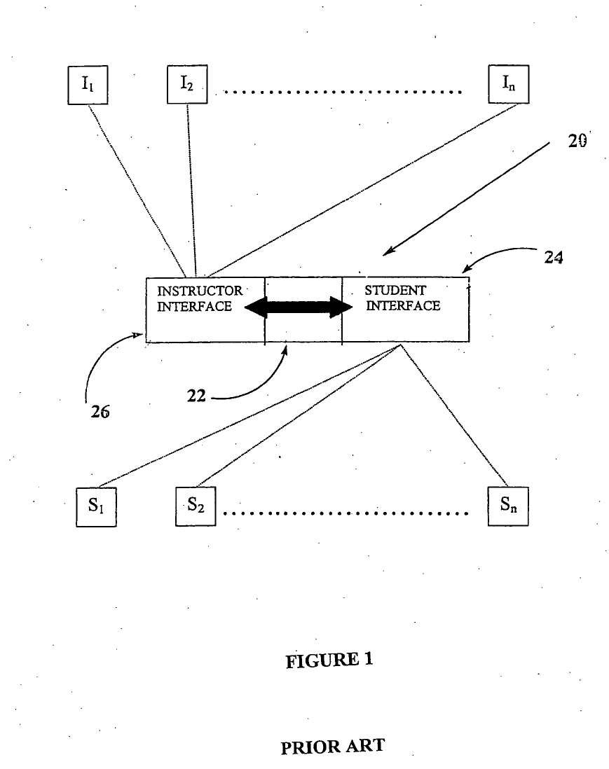

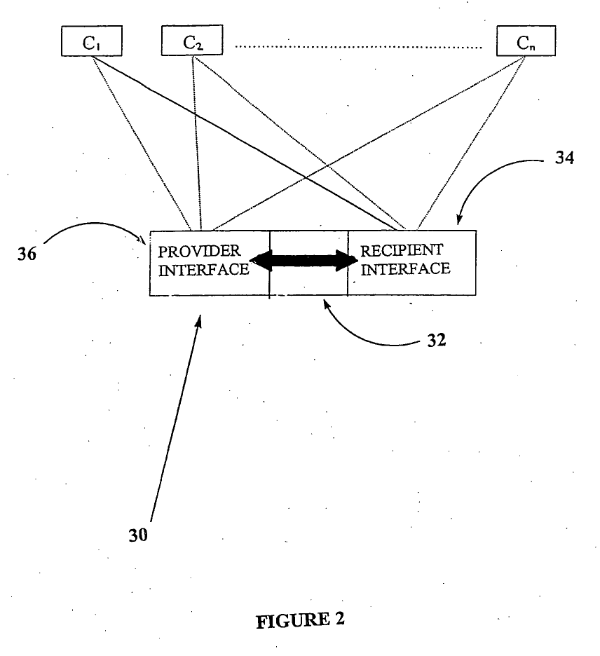

The general architecture of an open university of the kind hitherto available can be seen in FIG. 1, which was described above. The general architecture of a VCEM in accordance with the invention can be seen in FIG. 2. The VCEM 30 is provided with one or more servers 32 and has a recipient/student interface 34 and provider/instructor interface 36. However, unlike prior art systems, there is no a priori defined hierarchy of clients segregating them between providers on the one hand and recipients on the other hand. Rather, in accordance with the invention, each of the plurality of clients C₁, C₂ . . . Cₙ, can define himself either as a provider or as a recipient and accordingly connect to the system through the provider or the recipient interface, respectively.

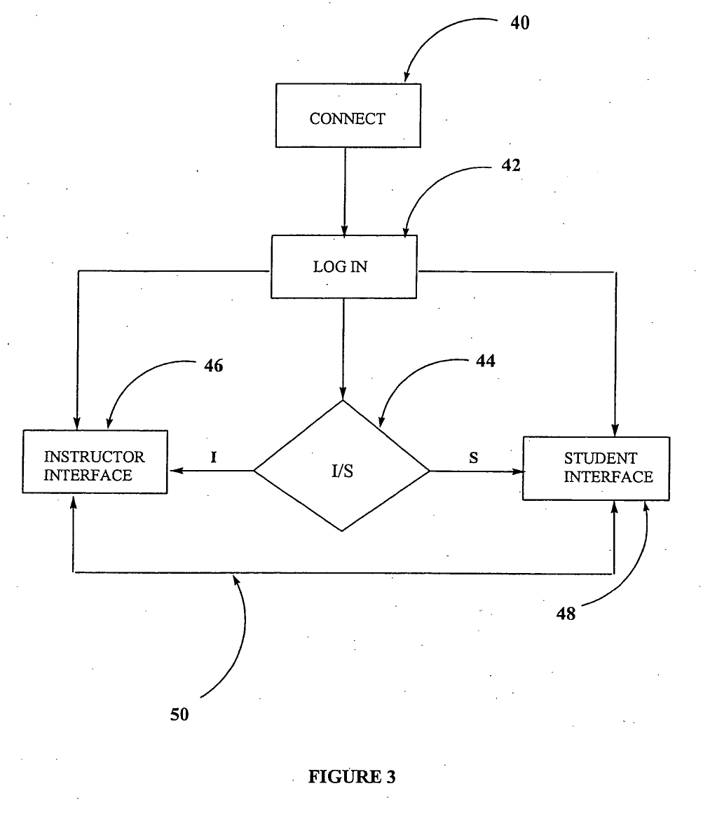

A generalized connecting sequence to the server is represented in FIG. 3. After a user connects to the system at 40, a log on sequence 42 is initiated in which the user indicates whether he is an existing client, a new client or an incident visitor, an existing client typically needs to put in his user name and password. Then in decision step 44 the client defines himself as an instructor (I) or a student (S) and is prompted either into an instructor interface 46 or a student interface 48, respectively. Optionally, the system may identify a client, based on past history, as an instructor or a client and prompt him automatically, following the log in sequence 42, directly into either the instructor interface 46 or a student interface 48. These interfaces may also include a link, represented by double arrowed line 50, permitting a client to switch from one interface to another.

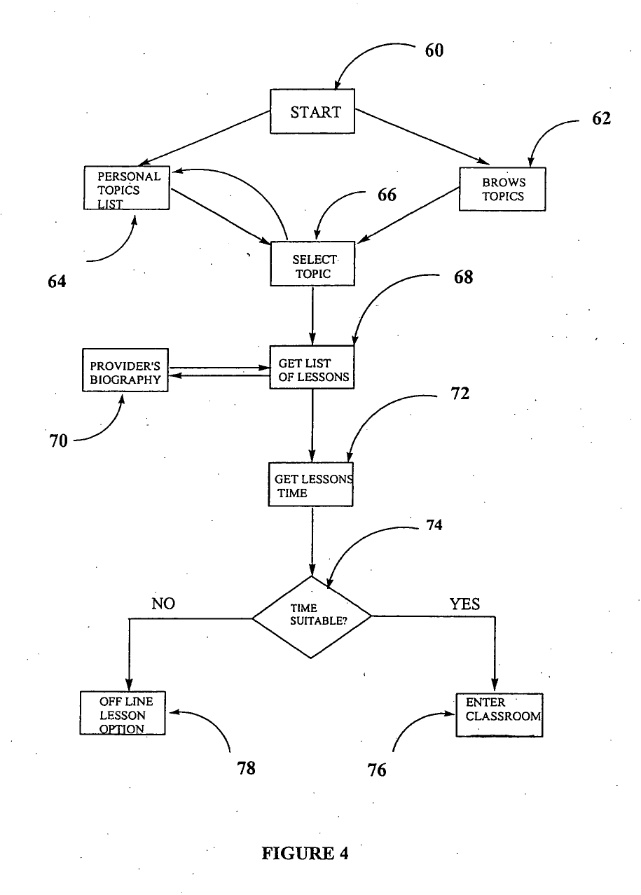

FIG. 4. provides an exemplary flow chart of the sequences involved in selecting and participating in a certain teaching session. Following entry 60 to the student interface the students may typically select to browse overall topics/lists 62 or a personal topic list 64 constructed according to preferences defined by the client when first registering to the system, or a list of topics previously defined by the client. A topic may be selected 66 and if not included, may then be added to the personal topic list. After the topic is selected, the list of different lessons or courses relating to this topic may be provided 68 and by selecting an icon, the student client may get the instructor's biography 70, past experience, and evaluations by other students, etc. Then, lesson time may be retrieved 72, and if time is suitable 74, the student may choose to “enter the classroom” 76, namely participate in the lesson live when it is given, or choose to receive a recorded lesson for playback by the student at a suitable time 78.

The student is typically provided with an agent software enabling the student to connect through his personal computer from a remote location to a live and interactive learning session in the virtual classroom. By the use of the agent software the student will be able to monitor the progress of the teaching session in the virtual classroom. This may include, for example, viewing a virtual blackboard on which the instructor may write notes, formulae, sketches, drawings, etc. In addition, the student software may be provided with an audio feature permitting the students to hear the instructor while delivering content. Optionally, the agent software may also be provided with a feature permitting the student to view an image of the instructor which may be a still image or a live video image.

The client software may also allow the students to enter into a dialog with the instructor, which may be a voice dialog using voice communication protocols, or by transmitting text messages, or comprise transmission of data files, e.g. a paper prepared by the student, etc. In addition, the student software may also allow him to make a drawing or write a note on the virtual blackboard which can then be visualized by the instructor and the other students. The student software may also be featured to permit the students to see and practice the instructor's shared software applications, share his desktop with the instructor, record a live session and later playback a recorded session.

The instructor application software enables the instructor to prepare a lesson and conduct a live interactive teaching session in front of a virtual classroom of students. By the use of the application software the instructor may be able to establish one way or two way voice communication with the students. Optionally, the application software permits him to prepare learning material offline, and provide such material to students during the live session. The software may also permit the instructor to share a software application with the students during a teaching session. In addition, the instructor software may also permit the instructor to post questions and present tests for students as well as to monitor the student's responses.

In order to register as an instructor, a client will typically be required to fill an electronic form providing personal information, credentials, and topics that he wishes to teach. Subsequently the instructor will typically go through a procedure of opening an account. As part of the registration sequence, an instructor may also download the instructor's software or alternatively this software may be sent to him on a computer readable medium such as a CD ROM or a magnetic disk.

Clients wishing to register as students of the system follow a substantially similar procedure although the type of information required from them is obviously different.

A client who has previously been a student or instructor may obviously change his status respectively into an instructor or a student, or assume a dual status both as an instructor or a student. At any time a client of the system may open an appropriate dialog box, provide the relevant details and change his status.

The teaching sessions or courses will typically be posted on a course page and a client or an incidental “visitor” may browse a list of teaching sessions or courses which will usually contain the title of the specific lesson or course, the name of the instructor, usually with a link to his biography, a short description of the topic, whether the course consists of live or pre-recorded sessions, links to a user feedback about the instructor and the course, information about the number of students currently signed up or the number of students that completed the course, and other details. In the course is delivered live, the client reviewing the list may also receive information regarding the schedule of the course.

Before a teaching session begins, the system will typically post an E-mail to notify the instructor regarding the number of students registered and will also post an E-mail message to the students to remind them of the schedule of the lessons, and the lesson material required by the students. In an exemplary embodiment of the invention, large data files or video files, papers for prior reading, etc., may be pushed to the students prior to the teaching session. At the time of a live event the instructor and the students will enter the VCEM campus through an authorized system giving their user ID and password and will then be logged into the virtual classroom where the teaching session will take place. Optionally teaching sessions may be recorded and later provided as non-live courses.

In an exemplary embodiment of the invention, a course may be provided on the condition that a minimum number of students enroll to participate in the course. Optionally, some courses may be provided as private lessons wherein participation in the course is limited to a single student.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

Section headings are provided for assistance in navigation and should not be considered as necessarily limiting the contents of the section.

It will be appreciated by persons skilled in the art that the present invention is not limited to what has been particularly shown and described hereinabove. Rather the scope of the present invention is defined only by the claims, which follow.

1. An interactive system for the exchange of knowledge over a network, comprising:
a server that is accessible by user client stations via a communication network;
an interactive knowledge exchange application for running on said server;
wherein said application is adapted to enable a user to log on to use said application as an instructor or a student;
wherein a user logged on as an instructor can provide an online course for teaching students; and
wherein a user logged on as a student can select to participate online in courses offered by instructors.

2. A system according to claim 1, wherein said application allows the instructor to specify a schedule for the provided course.

3. A system according to claim 1, wherein said application allows the instructor to specify a fee for the provided course.

4. A system according to claim 1, wherein said application allows the instructor to specify the subject of the provided course.

5. A system according to claim 1, wherein said provided course is conducted with live participation of the instructor.

6. A system according to claim 5, wherein said application provides the instructor with a virtual blackboard, which displays for the students the content which is provided by the instructor.

7. A system according to claim 5, wherein said application provides the instructor with live voice communication to the participating students.

8. A system according to claim 5, wherein said application provides the students with live voice communication with the instructor.

9. A system according to claim 5, wherein said application provides the students with live voice communication among themselves.

10. A system according to claim 5, wherein said instructor controls communication between the participating students.

11. A system according to claim 1, wherein said application enables the delivery of course material to the participating students.

12. A system according to claim 1, wherein said application provides the instructor with the ability to selectively send messages to participating students.

13. A system according to claim 1, wherein said application enrolls students wishing to participate in a course.

14. A system according to claim 1, wherein said application accepts payment from students to participate in a course.

15. A system according to claim 1, wherein said application conducts a list of available courses.

16. A system according to claim 15, wherein said list can be searched by the subject of the available courses, the popularity of the available courses, the quality of the available courses, the length of the available courses, or the price of the available courses.

17. A system according to claim 1, wherein said application provides payment to the instructors for providing a course based on the participation in the course.

18. A system according to claim 1, wherein said application enables participants of a course to contact each other.

19. A system according to claim 1, wherein said application provides a course instructor with a list of the participants.

20. A system according to claim 1, wherein said application provides a course participant with a list of the participants in the course.

21. A system according to claim 1, wherein said application accepts feedback from the course participants ranking the quality of the course.

22. A system according to claim 1, wherein said application accepts feedback from the course participants ranking the ability of the instructor.

23. A system according to claim 1, wherein said application enables multiple instructors to conduct a course together from different workstations.

24. A system according to claim 1, wherein participation in a course requires installation of an agent application on the client station.

25. A system according to claim 24, wherein said agent application prevents copying content provided to the student.

26. A system according to claim 24, wherein said agent application assures payment for participation in a course.

27. A system according to claim 24, wherein said agent application tracks usage of course material by the student.

28. A system according to claim 24, wherein said agent application limits usage of course material to a specific time schedule.

29. A system according to claim 24, wherein said agent application allows access to the student workstation by the instructor.

30. A system according to claim 1, wherein said application accepts requests and provides a list of subjects of interest for instructors to provide courses.

31. A system according to claim 1, wherein said application enables communication between clients of the system for the exchange of information.

32. A system according to claim 1, wherein said application provides instructors with feedback from the students regarding courses provided by the instructor.

33. A system according to claim 1, wherein said application prevents provision of courses on offensive subjects.

34. A system according to claim 1, wherein said application prevents provision of courses by undesirable instructors.

35. A system according to claim 1, wherein said application provides students the ability to view sample lessons.

36. A system according to claim 1, wherein said system takes a percentage of any payment collected from a student for participating in a course.

37. A system according to claim 1, wherein said application records live courses and offers them at a later time as not live courses.

38. A system according to claim 1, wherein a course may be provided on condition that a minimum number of students participate.

39. A system according to claim 1, wherein a course may be limited to be provided to a single student.

40. A system according to claim 1, wherein a course may be provided to a limited number of participants providing the highest price bid.
